(19) United States
(12) Patent Application Publication
(10) Pub. No.: US 2009/0009870 A1
(43) Pub. Date: Jan. 8, 2009

(54) DAYLIGHTING FILM AND WINDOW EQUIPPED THEREWITH

(75) Inventor: Yoshihisa USAMI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/765,589

(22) Filed: Jun. 20, 2007

(30) Foreign Application Priority Data
Aug. 3, 2006 (JP) 2006-212575

(51) Int. Cl. G02B 17/00

(52) U.S. Cl. 359/592

(57) ABSTRACT

The present invention is to provide a daylighting film that can provide incident sunlight from a window to indoor spots such as the ceiling and visibility from the indoors to the outdoors, and can easily be placed on the window, and also to provide the window that is equipped with the daylighting film. The daylighting film of the present invention contains a translucent support 2, and on at least one surface of the translucent support, unit prisms 3 and plain areas 4 are formed.

### BACKGROUND OF THE INVENTION

1. Field of the Invention

The present invention relates to a daylighting film and a window equipped therewith.

2. Description of the Related Art

Japanese Utility Model Application Laid-Open (JP-U) No. 7-39008, Japanese Patent Application Laid-Open (JP-A) Nos. 2001-305473 and 2000-28956 propose techniques to efficiently take incident sunlight from windows into the indoors.

Those disclosed three methods, however, require large-scale installations because the methods aim at taking a great amount of sunlight into the indoors. Then, techniques to efficiently take sunlight using louvers and slats (window shades) are proposed in JP-A Nos. 2004-278068, 2000-170467, 11-36739, 2004-363042, 10-317850 and 11-315673.

Those six disclosed methods use window shades, and are effective in taking direct sunlight. However, because the window shades are originally used to shut out incident sunlight, the window shades used in the methods cannot take sunlight other than direct sunlight, resulting in a reduction in the efficiency in taking sunlight.

Moreover, with the use of the window shades disclosed in the methods, areas, through which sunlight cannot go, of the windows look dark when looked from the indoors, resulting in a reduction in comfortableness with the use of the windows. Furthermore, the indoors becomes remarkably dark under a cloudy sky.

Thus, JP-A No. 8-313795 and 11-280350 respectively propose locating prisms on windows as a method to take both direct and indirect sunlight to brightly lighten the indoors even under a cloudy sky.

However, prisms used in the technique of JP-A No. 8-313795 are excessively large to be placed on commonly used windows located in houses, and thus the method lacks usability. The technique disclosed in JP-A No. 11-280350 has a configuration in which a resin sheet with prisms formed on a surface thereof is only affixed to a window, and thus the method lacks inventiveness in efficiently providing sunlight for the indoors and, in particular, to ceilings.

Additionally, the usability of the techniques proposed in the above-mentioned JP-A Nos. 8-313795 and 11-280350 is remarkably poor to be used in common houses because, first, they require a great effort at installations, and secondly, the outer surface of prisms formed for refracting incident light covers the entire surface of a support, which would cause problems that dust will easily accumulate in gaps between the prisms. Further, as that dust cannot easily be removed, a reduction in the efficiency in taking sunlight cannot be prevented.

Therefore, as both a daylighting film that can provide incident sunlight from a window to desired indoor spots such as the ceilings, increase indoor illumination, allows for easy installation, easy cleaning, and ensuring visibility from the indoors to the outdoors, and a window equipped with the daylighting film have not yet been provided so far.

### BRIEF SUMMARY OF THE INVENTION

The object of the present invention is to solve the aforementioned problems and to achieve the following purposes. That is, the present invention is to provide a daylighting film that can provide incident sunlight from a window to desired indoor spots, increase indoor illumination, allows for easy installation, easy cleaning, and ensuring visibility from the indoors to the outdoors, and a window equipped with the daylighting film.

The means to solve aforementioned problems are as follows.

The daylighting film of the present invention contains a translucent support, and on at least one surface of the translucent support, unit prisms and plain areas are formed.

The window of the present invention is equipped with a daylighting film, the film which contains a translucent support and further contains unit prisms and plain areas which are formed on at least one surface of the translucent support.

### BRIEF DESCRIPTION OF THE SEVERAL VIEWS OF THE DRAWINGS

FIG. 1 is a perspective illustration exemplarily showing a configuration of the daylighting film of the present invention.

FIG. 2 is a perspective illustration exemplarily showing the form of unit prisms in another embodiment of the daylighting film of the present invention.

FIG. 3 is a schematic illustration exemplarily showing an embodiment of the window equipped with the daylighting film of the present invention.

FIG. 4 is a schematic illustration exemplarily showing a light path of incident light shined in through a window equipped with the daylighting film of the present invention.

FIG. 5 exemplarily shows a configuration of a production apparatus used for producing unit prisms in a production method of the daylighting film of the present invention.

FIG. 6 is a cross-sectional view exemplarily showing the configuration of the daylighting film of Example 2 in the present invention.

FIG. 7 is a cross-sectional view exemplarily showing the configuration of the daylighting film of Example 3 in the present invention.

FIG. 8 is a cross-sectional view exemplarily showing the configuration of the daylighting film of Example 4 in the present invention.

### DETAILED DESCRIPTION OF THE INVENTION

### (Daylighting Film)

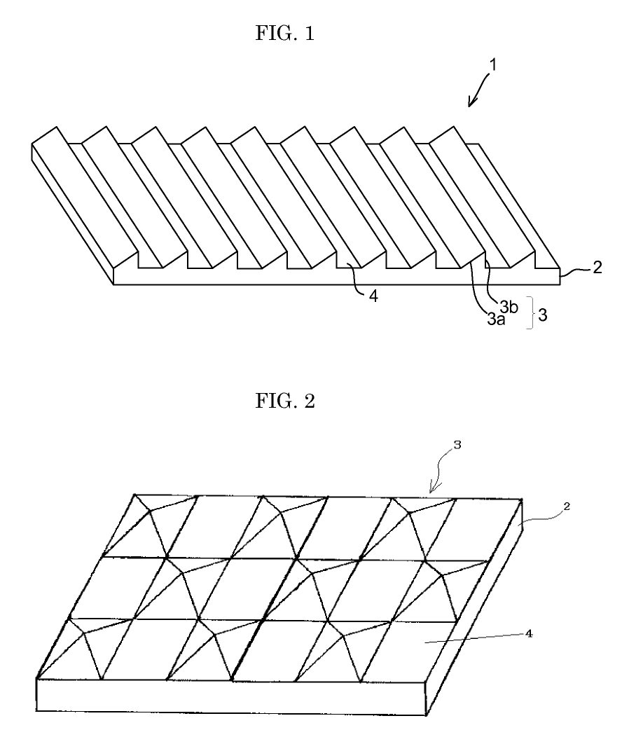

FIG. 1 is a perspective illustration showing the configuration of the daylighting film of the present invention.

As shown in FIG. 1, the daylighting film 1 of the present invention is composed of a support 2, unit prisms 3 which are formed on at least one surface of the support 2 for concentrating incident light passing through the film from the prisms to the support into a specific spot, and plain areas 4. Prism sheets and lenticular lenses are commonly used for such daylighting film 1. Besides those mentioned above, diffraction gratings and the like are also exemplified.

Each of the unit prisms 3 has at least two surfaces.

Additionally, the daylighting film 1 of the present invention may contain a light diffusion layer, a back layer, an intermediate layer and other layers in accordance with necessity.

### <Support>

The shape of the support 2 is not particularly limited, and can be a suitable shape in accordance with purpose. Examples of the shape include rectangle, square and round shapes.

The structure of the support 2 is not particularly limited, and can be a suitable structure in accordance with purpose. And it may be a single-layer or multi-layered structure.

The size of the support 2 is not particularly limited, and can be a suitable size in accordance with purpose.

The average thickness (T) of the support 2 is not particularly limited and can be a suitable thickness in accordance with purpose, provided that it is within the range of thickness typically used for support 2. The average thickness is preferably in the range of 10 μm to 10 mm, more preferably 5 μm to 5 mm, and further preferably 100 μm to 1 mm.

The average thickness of the support 2 can be measured with, for example, a thickness meter that measures a thickness of a film by sandwiching the film in between measurement sensors, and a non-contact thickness meter that measures thickness using optical interference.

Material of the support 2 is not particularly limited, provided it is translucent and has sufficient strength. Examples of the material include resins and glasses. Of those materials, resins are preferable because of their high plasticity and light weight.

The resin is not particularly limited, and can be selected in accordance with necessity. Thermoplastic resins and thermosetting resins are exemplified.

Examples of the thermoplastic resins include polymethyl methacrylate resins (PMMA), polycarbonate resins, polystyrene resins, MS resins, AS resins, polypropylene resins, polyethylene resins, polyethylene terephthalate resins, polyvinyl chloride resins (PVC), thermoplastic elastomer or copolymers thereof and cycloolefin polymers. Those resins can be used alone or in combination.

The haze of the support 2 is 50% or less, preferably 30% or less, and more preferably 10% or less. When that haze is more than 50%, efficiency in taking and controlling incident light, or light concentration efficiency, may be significantly degraded.

As used hereinafter, the term “haze” means that percentage of transmitted light which in passing through the specimen deviates from the incident beam by forward scattering, and values thereof can be measured with measurement devices such as HZ-1 (a haze meter, manufactured by Suga Test Instruments) conforming to JIS 7105 standard.

### <Unit Prism>

The daylighting film of the present invention is configured by forming prisms instead of forming one prism on the support 2, so that it can efficiently concentrate light into a specific spot. And each of the prisms is called a unit prism 3 in the present invention.

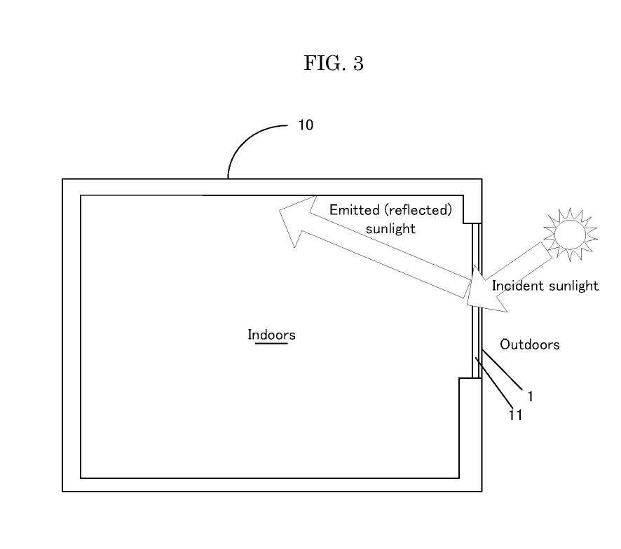

The shape of the unit prisms 3 formed on the support 2 is not particularly limited, and can be selected from shapes in accordance with purpose, provided that the shape is suitable for efficiently concentrating emitted light, emitted from the support 2, into a specific spot such as a ceiling. Examples of shapes that can be used for the unit prisms 3 include a plurality of triangular unit prisms (hereinafter, it may be called a prism column) whose sidelines are arranged parallel to each other on the support 2 as shown in FIG. 1; and quadrangular pyramid shaped-unit prisms arranged in lattice arrangement as shown in FIG. 2.

Of those shapes, the prism column is preferable because of its high production efficiency.

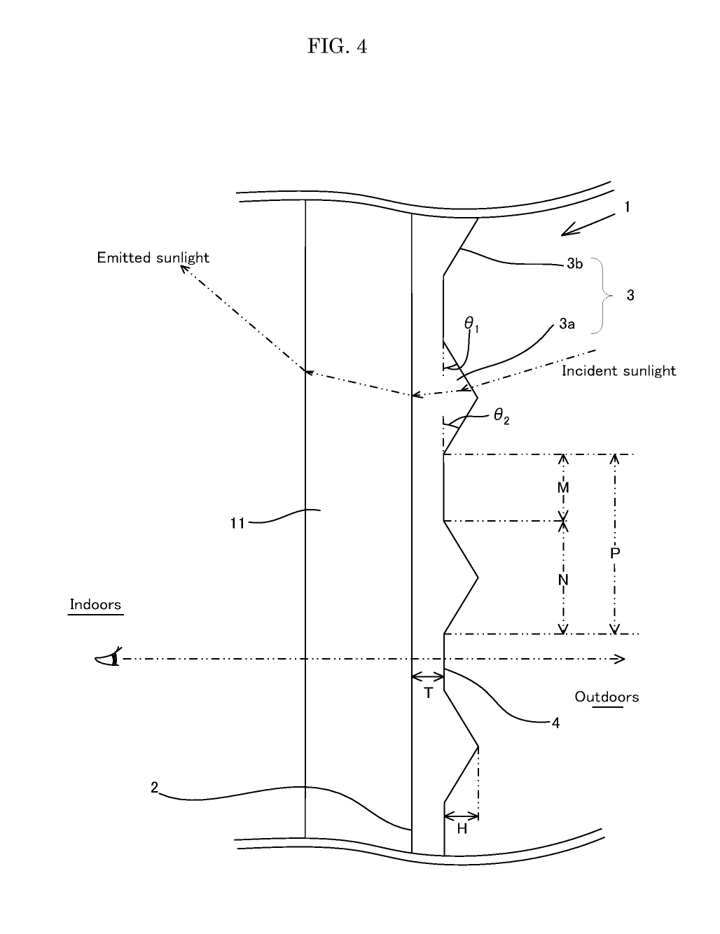

FIG. 4 shows a light path of incident sunlight passing through a window 11 located in the indoors 10. The window is equipped with the daylighting film 1 of the present invention, on which the unit prisms 3 are formed. As shown in FIG. 4, sunlight coming from the outdoors is refracted at a first surfaces 3a of each of the unit prisms 3, passes through the support 2, is refracted at the reference surface (the face placed on the window 11) of the support 2, passes through the window 11 and is refracted at the indoor surface of the window 11 to thereby be emitted to the ceiling.

In respect of the size of the unit prisms 3, the pitch P, or an interval between two unit prisms 3, is preferably in the range of 1 μm to 10 mm, more preferably 5 μm to 5 mm, and further preferably 10 μm to 1 mm.

The unit prisms preferably has a height H of 10 μm to 10 mm from the surface of the support 2. It is more preferably in the range of 50 μm to 5 mm, and further preferably 100 μm to 1 mm.

The elevation angle θ, an angle to the surface of the support 2, of the unit prisms 3 is preferably in the range of 5° to 75°, more preferably 10° to 60°, and further preferably 20° to 45°, and is particularly preferably 30°.

The width N of the unit prisms 3 is preferably in the range of 1 μm to 10 mm, more preferably 5 μm to 5 mm, and further preferably 10 μm to 1 mm.

Additionally, the elevation angle θ of the unit prisms 3 to the support 2 may vary in each unit prism depending on where each prism is placed. For example, in a daylighting film composed of a support 2 on which unit prisms 3 are formed in columnar arrangement, elevation angles of unit prisms formed at a lower position may be larger or smaller than that of unit prisms formed at an upper position in order to narrow the angle of light refracted at the indoor surface of the window so that light emitted will be more concentrated at the ceiling.

Edges of the first surface 3a and second surface 3b of the unit prisms may be chamfered.

### <Plain Area>

Not only the unit prisms 3, but also plain areas 4 which are to provide visibility from the indoors to outdoors through the daylighting film 1 are formed on at least one surface of the support 2. The plain areas 4 are substantially parallel to the reference surface of the support 2 or the surface of the window 11 on which daylighting film 1 is placed.

The plain areas 4 may be formed such that the plain areas and unit prisms are formed alternately at intervals, or may be formed by forming unit prisms on the entire surface of the support 2 and pruning away every one or more unit prisms to form plain areas.

As shown in FIGS. 1 and 2, the plain areas 4 may be formed alternately with the unit prisms 3 with a predetermined interval on one surface of the support 2. Or the plain areas 4 may be formed between groups of two or more unit prisms formed in a row.

The width M of each of the plain areas 4 is preferably in the range of 1 μm to 10 mm, more preferably 5 μm to 5 mm, and further preferably 10 μm to 1 mm. The relationship between the above mentioned pitch P, width N of each of the unit prisms 3 and width M of each of the plain areas 4 satisfies the equation, P=M+N.

Because the daylighting film 1 of the present invention has the plain areas 4 formed on the support 2, the film provides visibility from the indoors to outdoors through the daylighting film 1. Further, because the film has fewer gaps in between two adjacent unit prisms 3, it has less dust in the gaps and is easier to clean than conventional daylighting films having unit prisms 3 on the entire surface of the support 2.

The daylighting film 1 of the present invention preferably has a ratio M/P of the pitch P of the unit prisms 3 and the width M of the plain areas 4 in the range of 0.3 to 0.8. When the ratio M/P is smaller than 0.3, visibility from the indoors to outdoors through the daylighting film may be degraded, and when larger than 0.8, sufficient light may not be taken in the indoors.

(Window Equipped with Daylighting Film)

As shown in FIG. 3, a window 11 equipped with the daylighting film of the present invention serves as a window which can efficiently take incident sunlight into the indoors and illuminate the indoors by concentrating that sunlight at a specific spot (such as the ceiling).

The method and place to locate the daylighting film 1 on the window 11 are not particularly limited, and they can be selected from suitable methods and places in accordance with purpose as long as effects induced by the unit prisms 3 are not impaired. It is preferable to place the daylighting film 1 to the window 11 such that the support 2 makes contact with the outdoor surface of the window 11 using a translucent adhesive or the like. That enables higher light concentration ability of the film than in a case where adhesion, existing between the prisms 3 and the window 11 for fixing the prisms on the window, is used. Thus, by fixing the surface of the support on the window 11, that reduction can be prevented.

Additionally, the surface of the support 2 may be fixed on the indoor side of the window 11, depending on a shape of unit prism 3. In such case, the daylighting film 1 can be prevented from its deterioration caused in the outdoor environment.

### Light Diffusion Layer

In the present invention, a light diffusion layer (not shown in figures) may be formed on the support 2 in accordance with necessity. The light diffusion layer can be formed by applying a coating solution which is composed of a resin, a volatile liquid and particles onto the support 2 and drying that applied coating solution to form a coated layer.

The components of the coating solution include a resin, a volatile liquid and particles. And it may contain other components in accordance with necessity.

The resin is not particularly limited, and can be selected from suitable resins according to purpose. Examples thereof include acrylate resins and styrene-butadiene resins.

Examples of the volatile liquid include methylethylketones (MEK), cyclohexanones, toluenes and water.

The shape of the particles may be spherical or elliptical sphere or comma-shaped.

The average particle diameter of the particles is preferably larger than the average thickness of the coated layer, that is, it is preferably in the range of 0.5 μm to 50 μm.

The average particle diameter can be measured with a measurement device using, for example, a dynamic light scattering or a laser diffraction method.

The particles are not particularly limited, and can be selected from suitable particles. Examples of the particles include organic particles and inorganic particles.

The organic particle are not particularly limited, and can be selected from suitable particles. Examples of the particles include polymethyl methacrylate resin particles, melamine resin particles, polystyrene resin particles and silicone resin particles. Those resin particles can be used alone or in combination.

The organic particles preferably have a cross-linked structure.

Preferred examples of the organic particles having a cross-linked structure include acrylate resin particles that have a cross-linked structure.

The inorganic particles are not particularly limited, and can be selected from suitable particles. Examples of the particles include particles of talcs, calcium carbonates, silicones and aluminas. Those resin particles can be used alone or in combination.

The added amount of the particles is preferably in the range of 1 part by mass to 1,000 parts by mass, and more preferably 25 parts by mass to 400 parts by mass relative to 100 parts by mass of the resin. When the added amount of the particles is less than 1 part by mass, the particles may not serve as a light diffusing agent, and when more than 1,000 parts by mass, particles may not be sufficiently dispersed.

The ratio of the refractive index of the resin to the refractive index of the particles is not particularly limited, and can be adjusted at a suitable level according to purpose. For example, the ratio of refractive indexes of a D (n²⁵) line, measured at 25° C., is preferably in the range of 0.9 to 1.1, and more preferably 0.95 to 1.05.

When the ratio of the refractive indexes of the resin and particles is less than 0.9 or more than 1.1, the amount of reflected light component may be large at boundary surfaces of the particles and resin, resulting in a reduction of the vertical transmittance of light.

The other components are not particularly limited, and can be selected from suitable components according to purpose. Examples thereof include particle-anti-settling additives, fluorochemical surfactants, diffusing agents, thickeners, cationic surface active agents, anionic surface active agents, curing agents, cross linking agents, photopolymerization initiators and monomers.

Examples of the particle-anti-settling additives include fatty amides, polyethylene oxides, metallic soaps, organic bentonites and hydrogenated castor oil waxes. Of those anti-settling additives, fatty amides and oxidation polyethylenes are preferable. They can be used alone or in combination.

Since the diffusing agents serve as light diffusing agents similarly to the above-mentioned particles, they can further improve the light diffusion property.

The average particle diameter of the diffusing agents is not particularly limited, and can be adjusted at a suitable diameter according to purpose. For example, it is preferably in the range of 1 μm to 5 μm.

The average particle diameter of the diffusing agent is not particularly limited, and can be measured with measurement devices using, for example, a dynamic light scattering or a laser diffraction method.

Materials of the diffusing agents are not particularly limited, and can be selected from, for example, silicas, calcium carbonates, aluminas and zirconias.

The added amount of the diffusing agents in the coating solution is not particularly limited, and can be adjusted at a suitable level according to purpose. For example, it is preferably in the range of 1 part by mass to 20 parts by mass relative to the total amount of the coating solution.

The thickeners are not particularly limited, and can be selected from suitable ones. Examples thereof include acryl- or amide-amine salts.

The added amount of the thickener is preferably in the range of 0.1 parts by mass to 10 parts by mass relative to 100 parts by mass of the resin.

The fluorochemical surfactants are not particularly limited, and can be selected from suitable surfactants. Examples thereof include anionic fluorochemical surfactants and amphoteric fluorochemical surfactants.

The added amount of the fluorochemical surfactant is preferably in the range of 0.001 part by mass to 0.1 parts by mass relative to 100 parts by mass of the resin.

The surface tension of the coating solution is preferably 40N/m or less, and more preferably 30N/m or less. When the surface tension is more than 40N/m, the surface condition of the coated layer may be degraded.

The surface tension of the coating solution can be measured with, for example, CBVP-A3 (an automatic surface tension meter, manufactured by Kyowa Interface Science Co., Ltd.).

The viscosity of the coating solution is not particularly limited, and can be adjusted at a suitable level according to purpose. For example, it is preferably in the range of 10 mPa·s to 200 mPa·s, and more preferably 5 mPa·s to 150 mPa·s at 25° C. When the viscosity is less than 10 mPa·s, it may be difficult to maintain particle-sedimentation at a satisfactory level, and when more than 200 mPa·s, the flowability, paintability and surface condition of the coating solution may be degraded.

The viscosity of the coating solution can be measured with, for example, a type-E viscometer (an ELD type viscometer, manufactured by Tokyo Keiki Co., Ltd.).

The concentration of solid content in the coating solution is not particularly limited, and can be adjusted at a suitable level according to purpose. It is preferably in the range of 10 parts by mass to 40 parts by mass, and more preferably 20 parts by mass to 30 parts by mass relative to 100 parts by mass of the coating solution.

### (Production Method of Daylighting Film)

### <Forming Step of Unit Prism>

A method of forming unit prisms 3 on the support 2 in manufacturing the daylighting film 1 is not particularly limited, and may be selected from suitable methods according to purpose. Examples of the forming method include (1) forming prisms by feeding a resin sheet extruded from a die in between an embossing (transfer) roller that has a reversed pattern of the unit prisms 3 on the surface thereof and a nip roller to tightly press the resin sheet in between the embossing (transfer) roller and the nip roller to thereby transfer the pattern i.e. the shape of the unit prisms 3 to the surface of the resin sheet. The embossing (transfer) roller rotates at almost same speed as the extrusion speed of the resin sheet. And the nip roller is placed facing the embossing roller. Additionally, for the forming method, (2) another method is also exemplified in which a transfer mold or a stamper having a reversed pattern of the unit prism 3 on the surface thereof is placed on a resin plate in a laminate structure, and the resin plate is pressed using a hot press to thermally transfer the reversed pattern to transfer the shape of the unit prisms 3 on the resin plate surface, thereby producing a daylighting film 1 with the unit prisms 3 formed thereon.

The examples further include (3) yet another method is also exemplified in which convexoconcaves, i.e., a reversed pattern of the unit prisms 3 formed on the surface of an embossing roller is transferred to a surface of a translucent film formed from polyester, cellulose acylate, acryl, polycarbonate, polyolefin or the like to form unit prisms 3 on the daylighting film, thereby producing a daylighting film 1.

More specifically, a sheet having unit prisms thereon may be produced by feeding a translucent film, the film formed by forming one or more adhesive and resin layers (such as a ultraviolet hardening resin layer) alternately, to the pattern roller to transfer the patterns, formed on the surface of the roller, to the resin layer(s), and hardening the resin layer(s) when the film is still in a contact state with the roller. The resin layer(s) can be harden by, for example, exposing to a ultraviolet radiation. Additionally, the adhesive may or may not be used.

Another example is that (4) forming a support having unit prisms thereon by pouring resin having the above-mentioned components into a metal mold with patterns of the unit prisms 3. In such case, the support 2, unit prisms 3 and plain areas 4 are formed into a single-piece product, rather than forming the support 2 and unit prisms 3 on the support using, for example, an embossing roller.

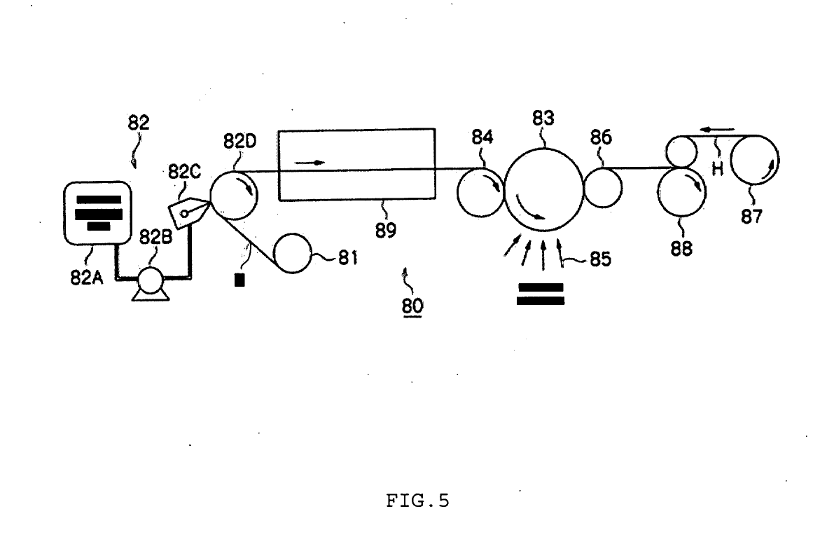

FIG. 5 shows an example of a production apparatus for forming the unit prisms 3. As shown in the figure, the apparatus 80 for forming the unit prisms 3 includes a coating unit 82, drying unit 89, an embossing roller 83 and a resin hardening unit 85.

For example, a translucent PET (polyethylene terephthalate) film which is 500 mm wide and 100 μm thick can be used for the support 2.

A roller which is 700 mm long (in the width direction of the support 2) and 300 mm in diameter made with S45C, a carbon steel, and covered with nickel may be used as an embossing roller 83.

For example, for making an embossing roller of that above-mentioned roller, grooves will be formed with a 50 μm pitch in the roller-axis direction on the entire circumference of the roller. The circumference may be about 500 mm long, and the grooves can be formed in a cutting process using a diamond cutting tool (with single point).

The cross sectional shape of the grooves may be triangle with an apex angle of 60°. In this case, plain areas between the grooves will be formed. That is, each of the grooves is 50 μm in width and 25 μm in depth.

The grooves are endless in the circumferential direction of the roller. Using the embossing roller 83, unit prisms 3 each having a triangle cross sectional shape and plain areas 4 can be formed on the support 2. The circumferential surface of the roller may be plated with nickel after the cutting process.

A die coater using an extrusion type coating head 82C is preferably used as a drying unit 82.

To form an organic solvent layer with a desired thickness after dried, the thickness of the coating solution (resin liquid) before dried will be controlled by adjusting the amount of each coating solution (resin liquid) supplied to the coating head 82C by a supply device 82B.

A circulating hot air dryer may be used as a drying unit 89. The temperature of hot air in the dryer is not particularly limited, and can be set at a suitable temperature according to purpose. It may be set at, for example, 100° C.

Likewise, the diameter and surface condition of the nip roller and nip pressure (effective pressure), applied to the support from the embossing roller 83 and nip roller 84, are not particularly limited and can be a suitable value/condition according to purpose.

A metal halide lamp and the like are preferably used as a resin hardening unit 85.

According to the present invention, a daylighting film that can solve conventional problems and provide incident sunlight from a window to desired indoor spots such as the ceiling, increase indoor illumination, allows for easy installation, easy cleaning, and ensuring visibility from the indoors to the outdoors, and a window equipped with the daylighting film.

### EXAMPLES

Hereafter, the present invention will be further described in detail referring to specific Examples and Comparative Examples, however, the present invention is not limited to the disclosed Examples.

### Example 1

### Production of Daylighting Film

### <<Preparation of Resin Liquid>>

The following composition was mixed and melting-mixed at 50° C. to prepare a resin liquid. The content rate of methylethylketone (MEK) in the obtained resin liquid was 16.7% by mass. And the viscosity of the resin liquid was 90 mPa·s.

Composition of the Resin Liquid

EB 3700 (EBECRYL 3700, a bisphenol-A type epoxy acrylate manufactured by DAICEL-CYTEC Company LTD., viscosity: 2,200 mPa·s at 65° C.)—35.0 parts by mass

BPE200 (NK ESTER BPE-200, ethylene-oxide added bisphenol-A methacrylic acid ester manufactured by Shin-nakamura Chemical Co., Ltd., viscosity: 590 mPa·s at 25° C.)—35.0 parts by mass

BR-31 (NEW FRONTIER BR-31 (solid under room temperatures/melt at 50° C. or higher), a tribromophenoxy ethyl acrylate manufactured by Dai-Ichi Kogyo Seiyaku Co., Ltd.)—30.0 parts by mass

LR 8893X (LUCIRIN LR 8893X, bis(2,6-dimethoxybenzoyl)-2,4,4-trimethylpentyl phosphine oxide, a radical generator manufactured by BASF Chemical)—2.0 parts by mass

MEK (methylethylketone)—20.5 parts by mass

Next, a support 2 was prepared. Then, using the production apparatus for unit prisms as shown in FIG. 5, a daylighting film 1 was produced.

A translucent PET (polyethylene terephthalate) film which was 500 mm wide and 100 μm thick was used for the support 2.

A roller which was 700 mm long (in the width direction of the support 2) and 300 mm in diameter made with S45C, a carbon steel, and covered with nickel was used as an embossing roller 83. For making an embossing roller, grooves with a pitch of 50 μm in the roller-axis direction were formed on the entire circumference which was about 500 mm long of the roller by a cutting process using a diamond cutting tool (having single point).

The cross sectional shape of the grooves was triangle with an apex angle of 60°. Plain areas were formed between the grooves. That is, the grooves were 50 μm in width and 25 μm in depth. The grooves were endless in the circumferential direction of the roller. Using the embossing roller 83, unit prisms 3 having triangle cross sectional shapes and plain areas 4 were formed on one surface of the support 2. The circumferential surface of the roller was plated with nickel after the cutting process for forming the grooves.

A die coater using an extrusion type coating head 82C was used as a drying unit 82.

A resin liquid having the same composition as the daylighting film was used as a coating solution. To form an organic solvent layer 20 μm in thick after dried, the thickness of the coating solution (resin liquid) before dried was controlled by adjusting the amount of each coating solution (resin liquid) supplied to the coating head 82C using a supply device 82B.

A circulating hot air dryer was used as a drying unit 89. The temperature of hot air in the dryer was set to 100° C.

A roller which was 200 mm in diameter covered with a silicone rubber layer with rubber hardness of 90 degree was used as a nip roller 84. The nip pressure, effective pressure applied to the support from the embossing roller 83 and nip roller 84, was 0.5 Pa.

A metal halide lamp was used as a resin hardening unit 85. The resin was irradiated with radiation energy of 1,000 mJ/cm2.

And thus a daylighting film which was 90 cm wide and 120 cm long having patterns such as one shown in FIG. 4 was produced.

In the obtained daylighting film 1, the pitch P, or an interval between two unit prisms 3, was 100 μm; the height H of the unit prisms was 43 μm from the support 2; the upper elevation angle θ₁, an angle to the support 2, of the unit prisms 3 was 30°; the lower elevation angle θ₂, an angle to the support 2, of the unit prisms 3 was 30° (the apex angle of the unit prisms 3 was 120°); the width N of each of the unit prisms 3 was 50 μm; and the width M of each of the plain areas 4 was 50 μm.

<Evaluation of Window Equipped with Daylighting Film>

Evaluations of the thus obtained daylighting film 1 was conducted as to in the illuminance and vertical transmittance. The daylighting film was placed on the window 11 located in the indoors 10. The obtained results are shown in Table 1.

### <<Evaluation of Illuminance>>

In the evaluation, the “near window” was defined as an indoor spot which is at the same height as the windowsill of and about 1 m away from the window 11, and the “far window” was defined as an indoor spot which is at the same height as the windowsill of and about 10 m away from the window 11. The daylighting film 1 of the present invention was placed on the window 11, and illuminances (lux) of the near window and far window were measured. Note that, the illuminance of the far window was a measured illuminance as a result that of light reflected several times in the indoors. <<Evaluation of Vertical Transmittance>>

In the present invention, the term “vertical transmittance” means the ratio of (illuminance of light that passed a window equipped with the daylighting film of the present invention) and (illuminance of light that passed a window not equipped with the daylighting film of the present invention). The vertical transmittance was obtained by measuring illuminances of light that passed the window 11, equipped with the daylighting film 1 of the present invention, from one direction and light that passed the window 11 not equipped with the daylighting film 1 of the present invention from one direction. Light was vertically injected into the windows, and the illuminances were measured using an illuminance meter.

### Example 2

### Production and Evaluation of Daylighting Film

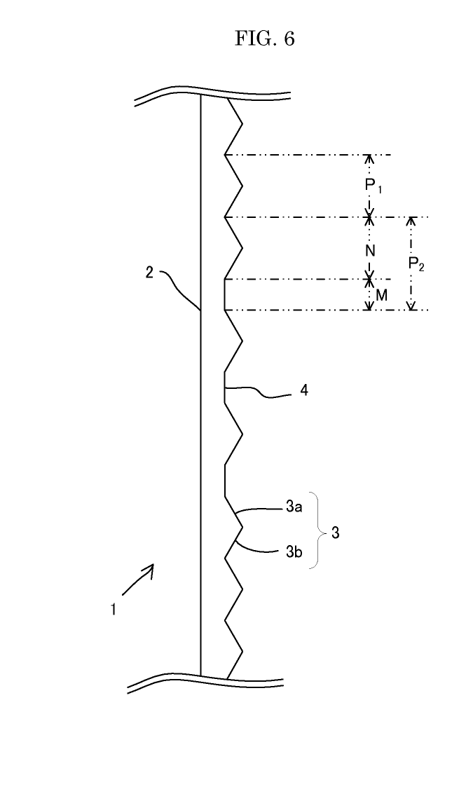

A daylighting film 1 was produced in the same manner as in Example 1 except that, as shown in FIG. 6, pitches P₁ of upper/lower unit prisms 3 and plain areas 4 differed from pitches P₂ of middle unit prisms and plain areas.

More specifically, the pitches P₁ was 50 μm (the width N of the unit prisms 3 was 50 μm and the width M of the plain areas 4 was 0 μm) and pitches P₂ was 70 μm (the width N of the unit prisms 3 was 50 μm and the width M of the plain areas 4 was 20 μm). The height H and elevation angles θ₁ and θ₂ of the unit prisms 3 were the same as those in Example 1.

In explanations of the daylighting film in the present invention, the term “upper” means a range from the top of the daylighting film 1 to 30 cm below the top. The term “lower” means a range from the bottom of the daylighting film 1 to 60 cm above the bottom. And the term “middle” means a range from 30 cm to 60 cm below the top of the daylighting film 1 (or a range from 60 cm to 90 cm above the top of the daylighting film 1).

The thus obtained daylighting film 1 was placed on the window 11, and evaluated in the same manner as in Example 1. The obtained results are shown in Table 1.

### Example 3

### Production and Evaluation of Daylighting Film

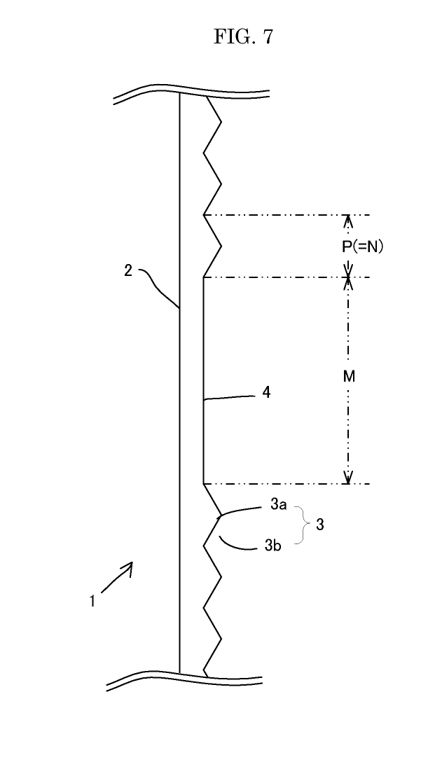

A daylighting film 1 was produced in the same manner as in Example 1 except that, as shown in FIG. 7, unit prisms 3 were not formed at the middle of a support 2 of the daylighting film and only plain areas 4 were formed instead of the unit prisms.

More specifically, pitches and width N of upper unit prisms 3 were 50 μm and pitches and width N of lower unit prisms 3 were 50 μm. And only plain areas 4 were formed at the middle, or between the upper and lower unit prisms. The height H and elevation angles θ of the unit prisms 3 were the same as those in Example 1.

The thus obtained daylighting film 1 was placed on the window 11, and evaluated in the same manner as in Example 1. The obtained results are shown in Table 1.

### Example 4

### Production and Evaluation of Daylighting Film

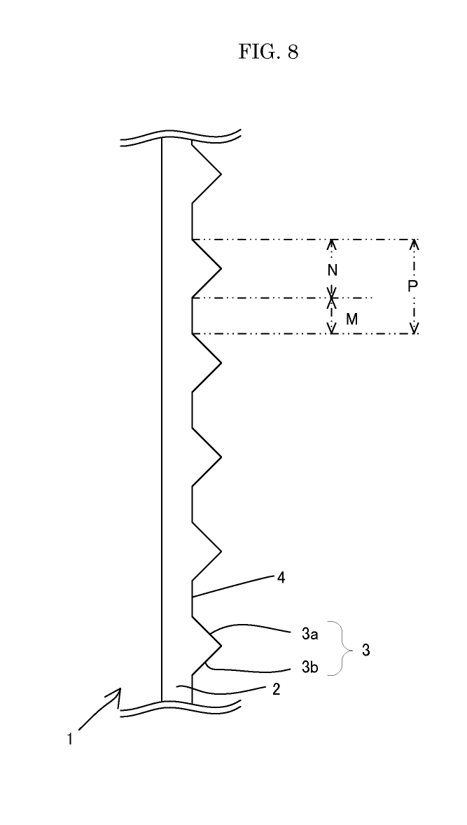

A daylighting film 1 was produced in the same manner as in Example 1 except that, as shown in FIG. 8, the elevation angles θ₁ (=θ₂) that is the degrees of surfaces 3a and 3b of the unit prisms 3 to the plain areas 4 was changed from 30° to a degree not vertical to the plain areas 4 so that the angles formed between the surfaces 3a and 3b was 90°.

The thus obtained daylighting film 1 was placed on the window 11, and evaluated in the same manner as in Example 1. The obtained results are shown in Table 1.

### Comparative Example 1

### Production and Evaluation of Daylighting Film

A daylighting film 1 was produced in the same manner as in Example 1 except that plain areas 4 were not formed and only unit prisms 3 were formed on one surface of a support 2.

More specifically, the unit prisms 3 with a pitch P and width N that is the width of the unit prisms 3 and was equal to the pitch P of 5 μm were formed on the entire surface of the daylighting film 1. The height H and elevation angles θ of the unit prisms 3 were same as those in Example 1.

The thus obtained daylighting film 1 was placed on the window 11, and evaluated in the same manner as in Example 1. The obtained results are shown in Table 1.

### Comparative Example 2

In Comparative Example 2, a window 11 equipped with no daylighting film was evaluated in the same manner as in Example 1. The obtained results are shown in Table 1.

TABLE 1

| | With or | | | |
|---|---|---|---|---|
| | Without | Iilluminance (lux) | | |
| | plain | Near window | Far window | Vertical |
| | areas | spot | spot | transmittance |
| Ex. 1 | with | 1,100 | 500 | 40% |
| Ex. 2 | with | 1,000 | 600 | 40% |
| Ex. 3 | with | 1,300 | 400 | 90% |
| Ex. 4 | with | 1,200 | 400 | 40% |
| Comp. Ex. 1 | without | 800 | 600 | 90% |
| Comp. Ex. 2 | — | 3,000 | 200 | 100% |

As the results shown in Table 1 show, the window 11 equipped with the daylighting film 1 of Example 1 provided an illuminance of 1,000 lux or higher at the near window, illumination at the far window, and visibility from the indoors to the outdoors.

As the results shown in Table 1 show, the window 11 equipped with the daylighting film 1 of Example 2 provided an illuminance of 1,000 lux or higher at the near window, a higher illumination at the far window than Example 1, and visibility from the indoors to the outdoors.

The window 11 equipped with the daylighting film 1 of Example 3 provided an illuminance of 1,000 lux or higher at the near window and excellent visibility from the indoors to the outdoors.

The window 11 equipped with the daylighting film 1 of Example 4 provided an illuminance of 1,000 lux or higher at the near window and visibility from the indoors to the outdoors, and helped illumination at the far window.

In contrast, the window 11 equipped with the daylighting film 1 of Comparative Example 1, the daylighting film that was composed of the support 2 and the unit prisms 3 formed on the one surface of the support 2 and formed without plain areas 4, provided illumination at the far window, but it provided no visibility from the indoors to the outdoors. In order to provide visibility from the indoors to the outdoors, a window equipped with a daylighting film needs to provide a certain level of illumination at the near window. The window 11 equipped with the daylighting film 1 of Comparative Example 1 provided no visibility from the indoors to the outdoors, and that is considered to be because the daylighting film 1 with the unit prisms 3 covering the entire surface thereof provided much incident sunlight from the window 11 to the far window, drastically reducing incident sunlight and the illuminance at the far window even with that 90% of vertical transmittance as shown in Table 1.

Furthermore, because the window 11 of Comparative Example 2 was not equipped with the daylighting film 1, the window provided an excessive illuminance at the near window while providing excellent visibility from the indoors to the outdoors. However, as the window 11 was not equipped with the daylighting film 1, a means to provide incident sunlight to the far window using the unit prisms 3, the illuminance was drastically reduced at the far window compared with the near window, thus the illuminance at the far window was fairly dark.

The daylighting film of the present invention can easily be placed on a window and sufficiently concentrate sunlight into a specific spot. Thus, it can preferably be used for not only a window but also a door, wall, roof and the like as a means to efficiently take sunlight therefrom into the indoors.

What is claimed is:

1. A daylighting film, comprising:
a translucent support,
unit prisms, and
plain areas,
wherein the unit prisms and the plain areas are formed on at least one surface of the support.

2. The daylighting film according to claim 1, wherein
each of the unit prisms has a ridge line in a direction, and
the unit prisms are arranged such that the respective ridge lines are parallel to each other at predetermined intervals in a direction perpendicular to the direction.

3. The daylighting film according to claim 1, wherein
the unit prisms and the plain areas are alternately formed on the support.

4. The daylighting film according to claim 1 having a vertical transmittance of 50% or less.

5. The daylighting film according to claim 1, wherein the ratio (M/P) of the pitch (P) between the unit prisms and the width (M) of each of the plain areas is in the range of from 30% to 80%.

6. A window, comprising:
a daylighting film which comprises a translucent support, unit prisms and plain areas,
wherein the unit prisms and the plain areas are formed on at least one surface of the support.
